(19) United States
(12) Patent Application Publication
(10) Pub. No.: US 2008/0186801 A1
(43) Pub. Date: Aug. 7, 2008

(54) BUBBLE MICRO-PUMP AND TWO-WAY FLUID-DRIVING DEVICE, PARTICLE-SORTING DEVICE, FLUID-MIXING DEVICE, RING-SHAPED FLUID-MIXING DEVICE AND COMPOUND-TYPE FLUID-MIXING DEVICE USING THE SAME

(75) Inventors: Cheng-Hsien Liu, Hsinchu City (TW); Long Hsu, Hsinchu City (TW); Chih-Ming Cheng, Changhua County (TW); Sheng-Hung Chiu, Taoyuan County (TW); Wai William Wang, Taoyuan County (TW); Chung-Cheng Chou, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QISDA CORPORATION, Taoyuan Shien (TW)

(21) Appl. No.: 12/014,813

(22) Filed: Jan. 16, 2008

(30) Foreign Application Priority Data
Feb. 6, 2007 (TW) 96104350
Jul. 6, 2007 (TW) 96124835

(51) Int. Cl. B01F 13/00; B01F 3/08; B01F 15/02; F04B 17/00

(52) U.S. Cl. 366/132; 366/165.4; 417/413.1

(57) ABSTRACT

A bubble micro-pump includes a first component, a second component and a bubble-generating unit. The first component includes a flow path having a first area and a second area. The second component above the first component has a first roughness surface and a second roughness surface. The first roughness surface opposite the first area has a first roughness factor, and the second roughness surface opposite the second area has a second roughness factor smaller than the first roughness factor. The bubble-generating unit on the first component generates bubble in the first area and the second area when a fluid fills the vacancy between the first component and the second component. Due to the difference in roughness factor, the backfilling velocity of the fluid in the first area is faster than that in the second area when the bubble starts to vanish, such that the fluid is driven to flow.

This application claims the benefits of Taiwan application Serial No. 96104350, filed Feb. 6, 2007, and Taiwan application Serial No. 96124835, filed Jul. 6, 2007, the subject matters of which are incorporated herein by reference.

### BACKGROUND OF THE INVENTION

1. Field of the Invention

The invention relates in general to a bubble micro-pump, and more particularly to a low power-consumption bubble micro-pump and two-way fluid-driving device, a particle-sorting device, a fluid-mixing device, a ring-shaped fluid-mixing device and a compound-type fluid-mixing device using the same.

2. Description of the Related Art

In the field of micro-electromechanically system, micro-pumps can be divided into two categories. Examples of the first category, which drives the fluid by mechanical components of the pump, include bubble pump, membrane pump, and diffuser pump. Such pumps have a blade structure, and the components of the pumps are capable of moving. However, if the micro-fluidic systems are configured with complicated mechanical components that have strict dimensional specifications, the micro-fluidic systems are subjected to many restrictions of technology.

Examples of the second category, which drives the fluid by an induced electric field, include electro-osmotic pump, electrophoretic pump and electro-wetting pump. Such pumps have a fixed electrode for receiving a voltage to generate an electric field to push the fluid. However, such pumps require complicated controlling signals and need to install a sensor in the micro-fluidic systems for detecting the properties of the fluid. The pumps are also subjected to many restrictions of technology.

### SUMMARY OF THE INVENTION

The invention is directed to a bubble micro-pump and two-wayway fluid-driving device, a particle-sorting device, a fluid-mixing device, a ring-shaped fluid-mixing device and a compound-type fluid-mixing device using the same. According to the invention, components have surface roughness and are further incorporated with the generation and vanishing of bubble. The backfilling velocity of the fluid is differentiated due to the difference in surface roughness, hence driving the fluid to flow.

According to a first aspect of the present invention, a bubble micro-pump including a first component, a second component and a bubble-generating unit is provided. The first component includes a flow path having at least a first area and a second area. The second component disposed above the first component has at least a first roughness surface and a second roughness surface. The first roughness surface opposite the first area has a first roughness factor, and the second roughness surface opposite the second area has a second roughness factor, wherein the first roughness factor is substantially greater than the second roughness factor. The bubble-generating unit disposed on the first component is used for generating bubbles in the first area and the second area when a fluid fills the vacancy between the first component and the second component. Due to the difference between the first roughness factor and the second roughness factor, the backfilling velocity of the fluid in the first area is faster than that in the second area when the bubbles start to vanish, such that the fluid is driven to flow.

According to a second aspect of the present invention, a two-way fluid-driving device including a first primary flow path, a second primary flow path, a first driving portion, a second driving portion and a controlling unit is provided. The first primary flow path and the second primary flow path are alternately disposed and together form a common flow path area. The first driving portion includes at least a bubble micro-pump disposed on the first primary flow path and adjacent to the common flow path area. The second driving portion also includes at least a bubble micro-pump disposed on the second primary flow path and adjacent to the common flow path area. The controlling unit is electrically connected with the bubble micro-pumps of the first driving portion and the second driving portion. When the controlling unit drives the first driving portion, the first driving portion pushes the fluid on the first primary flow path to flow. When the controlling unit drives the second driving portion, the second driving portion pushes the fluid on the second primary flow path to flow.

According to a third aspect of the present invention, a particle-sorting device including a primary flow path, a driving portion, a diversion portion, a detecting unit and a controlling unit is provided. The driving portion is disposed at the front part of the primary flow path. The diversion portion includes a first branch flow path connected with the rear part of the primary flow path, wherein a bubble micro-pump is disposed on the first branch flow path. The detecting unit is disposed on primary flow path and located between the driving portion and the diversion portion. The controlling unit is electrically connected with the detecting unit of the driving portion and the bubble micro-pump of the diversion portion. After the driving portion moves a particle-carrying fluid of the primary flow path for particles to pass the detecting unit to complete particle identification, the detecting unit transmits a signal to the controlling unit to drive the bubble micro-pump of the diversion portion, such that the particles flow to the first branch flow path along with the fluid.

According to a fourth aspect of the present invention, a fluid-mixing device including a mixing chamber, a first driving portion, a second driving portion and a controlling unit is provided. The mixing chamber includes an inlet flow path and an outlet flow path. The first driving portion includes at least a bubble micro-pump disposed on the inlet flow path. The second driving portion includes at least a bubble micro-pump disposed on the outlet flow path. The controlling unit is electrically connected with the bubble micro-pumps of the first and the second driving portion. After the controlling unit drives the first driving portion to introduce at least two fluids into the mixing chamber, the controlling unit alternately drives the second driving portion and the first driving portion for repeatedly guiding the two fluids to enter the mixing chamber via the inlet flow path and leave the mixing chamber via the outlet flow path, such that the two fluids are mixed.

According to a fifth aspect of the present invention, a ring-shaped fluid-mixing device including a ring-shaped primary flow path, two first branch flow paths, two second branch flow paths, a first driving portion, a second driving portion and a controlling unit is provided. The first branch flow paths and the second branch flow paths are connected with the ring-shaped primary flow path, wherein the second branch flow paths and the first branch flow paths are alternately disposed. The first driving portion includes two bubble micro-pumps both disposed on the ring-shaped primary flow path and respectively adjacent to a first branch flow path. The second driving portion includes two bubble micro-pumps both disposed on the ring-shaped primary flow path and respectively adjacent to a second branch flow path. The controlling unit is electrically connected with the bubble micro-pumps of the first driving portion and the second driving portion. After different fluids are introduced into the ring-shaped primary flow path via the first branch flow paths and the second branch flow paths, the controlling unit alternately drives the first driving portion and the second driving portion, such that the different fluids are mixed in the ring-shaped primary flow path.

According to a sixth aspect of the present invention, a compound-type fluid-mixing device including a first flow path component, a second flow path component and a controlling unit is provided. The first flow path component includes a ring-shaped primary flow path, at least an outlet flow path and an inlet flow path, a first driving portion and a second driving portion is provided. The outlet flow path and the inlet flow path are both connected with the ring-shaped primary flow path. The first driving portion is disposed at the junction of the ring-shaped primary flow path and the inlet flow path, and the second driving portion is disposed at the junction of the ring-shaped primary flow path and the outlet flow path. Each of the first driving portion and the second driving portion includes at least a bubble micro-pump. The second flow path component disposed above the first flow path component includes a direct flow path and a third driving portion, wherein the direct flow path is connected with the ring-shaped primary flow path. The third driving portion includes at least two bubble micro-pumps respectively disposed on two opposite sides of the junction of the direct flow path and the ring-shaped primary flow path. The controlling unit is electrically connected with the bubble micro-pumps of the first driving portion, the second driving portion and the third driving portion. After the controlling unit drives the first driving portion to introduce a fluid into the ring-shaped primary flow path via the inlet flow path and drives the third driving portion to introduce the other fluid into the ring-shaped primary flow path vie two sides of the direct flow path, the controlling unit alternately drives the first driving portion and the second driving portion for the two fluids to be mixed in the ring-shaped primary flow path. Furthermore, the second driving portion enables the mixed fluid to leave the ring-shaped primary flow path via the outlet flow path.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of a bubble micro-pump according to a first embodiment of the invention;

FIG. 2A is a perspective of a first component of the bubble micro-pump of FIG. 1;

FIG. 2B is a first perspective of a second component of the bubble micro-pump of FIG. 1;

FIGS. 3A˜3B are two second perspectives of the second component of the bubble micro-pump of FIG. 1;

FIG. 4A is a diagram showing the relationship of roughness factor ψ and contact angle θ according to the Cassie-Baxter theory;

FIG. 4B is a diagram showing the relationship of roughness factor and fluid pressure;

FIG. 5A is a cross-sectional view of the bubble micro-pump of FIG. 1;

FIGS. 5B˜5D are perspectives of the bubble micro-pump of FIG. 4B in continuous motion;

FIG. 6 is a diagram showing the relationship of voltage, frequency and flowing velocity according to the experimental results of the bubble micro-pump of FIG. 5A;

FIGS. 7A˜7B show the column elements of FIG. 2B formed by membranes;

FIG. 8 is a perspective of a two-way fluid-driving device according to the second embodiment of the invention;

FIGS. 9A˜9B are respectively a first and a second perspectives of a bottom component of the two-way fluid-driving device of FIG. 8;

FIG. 10A˜10B are respectively a first and a second perspectives of a top component of the two-way fluid-driving device of FIG. 8;

FIG. 11 is a first perspective of a particle-sorting device according to a third embodiment of the invention;

FIG. 12 is a second perspective of a particle-sorting device according to the third embodiment of the invention;

FIG. 13 is a perspective of a fluid-mixing device according to a fourth embodiment of the invention;

FIG. 14 is a perspective of a ring-shaped fluid-mixing device according to a fifth embodiment of the invention;

FIG. 15A is a top view of a compound-type fluid-mixing device according to a sixth embodiment of the invention;

FIG. 15B is a side view of the compound-type fluid-mixing device of FIG. 15A;

FIG. 16 is an exploded diagram of a bubble micro-pump according to a seventh embodiment of the invention; and

FIGS. 17A˜17C are perspectives of the bubble micro-pump of FIG. 16 in continuous motion.

### DETAILED DESCRIPTION OF THE INVENTION

### First Embodiment

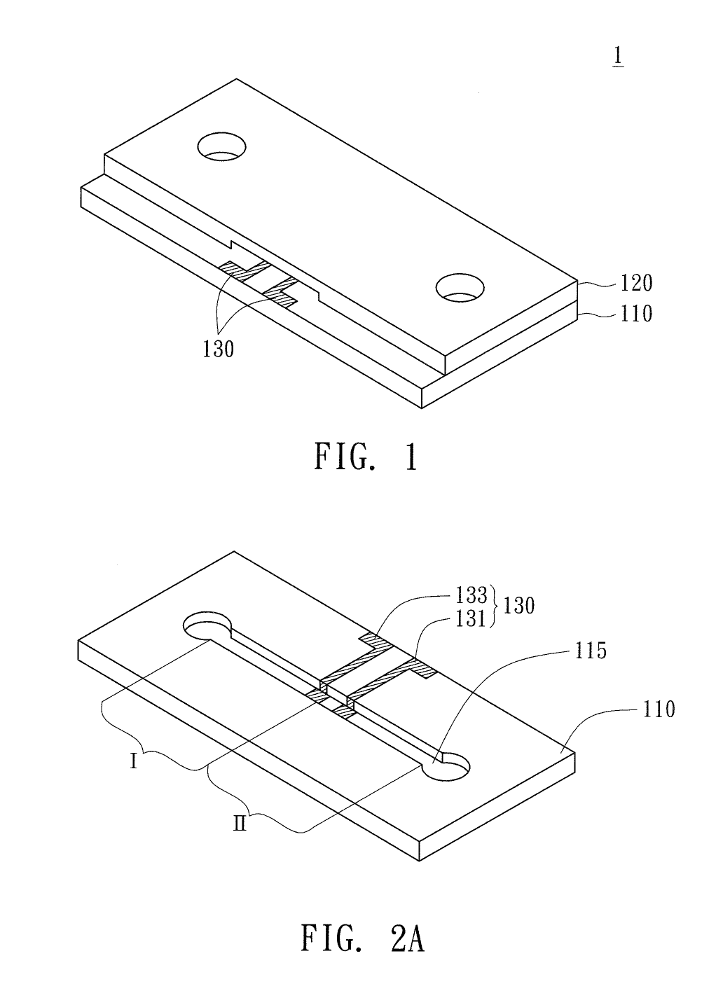

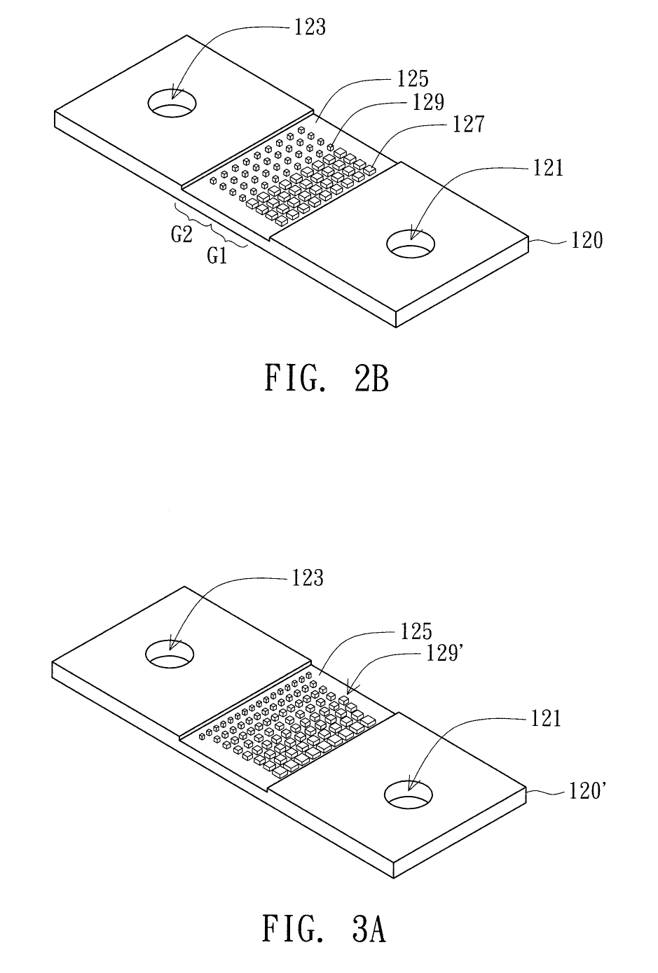

Referring to FIG. 1, a perspective of a bubble micro-pump according to a first embodiment of the invention is shown. As indicated in FIG. 1, the bubble micro-pump 1 includes a first component 110, a second component 120 and a bubble-generating unit 130. The second component 120 is disposed above the first component 110. The bubble-generating unit 130 is disposed above the first component 110. An air is generated between the first component 110 and the second component 120 when a fluid fills the vacancy between the first component 110 and the second component 120. Referring to FIGS. 2A-2B, FIG. 2A is a perspective of a first component of the bubble micro-pump of FIG. 1, and FIG. 2B is a first perspective of a second component of the bubble micro-pump of FIG. 1. As indicated in FIG. 2A, the first component 110 includes a flow path 115, and the flow path 115 has at least a first area I and a second area II. Preferably, the bubble-generating unit 130 is disposed in accordance with the first area I and the second area II of the first component 110. The flow path 115 of the first component 110 preferably includes a hydrophilic material such as glass or silicon dioxide. The first component 110 with the flow path 150 can be manufactured via the steps of exposing and developing.

The bubble-generating unit 130 includes an electrode set disposed on the first component 110. The electrode set includes a first electrode 131 and a second electrode 133, wherein the first electrode 131 corresponds to the first area I, and, the second electrode 133 corresponds to the second area II. The first electrode 131 and the second electrode 133, respectively connected with the positive polarity and the negative polarity of a driving power (not shown), have opposite polarities. The electrode set is made of an inactive metal such as gold or platinum, which would not react with chemistry easily.

As indicated in FIG. 2B, the surface of the second component 120 opposite the first area I of the first component 110 is a roughness surface having a first roughness factor ψ₁, and the surface of the second component 120 opposite the second area II is a roughness surface having a second roughness factor ψ₂, wherein the first roughness factor ψ₁ is greater than the second roughness factor ψ₂. Due to the difference between the first roughness factor ψ₁ and the second roughness factor ψ₂, when the bubble generated by the bubble-generating unit 130 starts to vanish, the backfilling velocity of the fluid in the first area I is faster than that in the second area II, such that the fluid is driven to flow.

Furthermore, the second component 120 has a fluid inlet 121 and a fluid outlet 123 corresponding to two sides of the first area I and the second area II, respectively. After the first component 110 and the second component 120 are assembled, the fluid enters the vacancy between the first component 110 and the second component 120 via the fluid inlet 121, flows through the flow path 150 of the first component 110, and leaves the vacancy between the first component 110 and the second component 120 via the fluid outlet 123. The second component 120 preferably includes a hydrophobic material. Examples of the hydrophobic material include a photoresist such as SU8 photoresist and a high polymer such as polydimethyl siloxane (PDMS). The second component 120 has a recess 125 on its surface for receiving the column elements. The micro-column structure constituted by the column elements and made from a thick film material such as SU8 or PDMS commonly used in micro-electromechnical manufacturing process is also manufactured via the steps of exposing and developing.

After the first component 110 and the second component 120 are assembled, a lateral exhaust hole is formed via the recess 125 of the second component 120. The second component 120 is made from a hydrophobic material, and preferably the hydrophobic material such as Teflon is coated on two lateral surfaces of the flow path 115 of the first component 110 for avoiding the fluid on the flow path 115 from leaking via the lateral exhaust hole. When the vacancy between the first component 110 and the second component 120 is filled with a fluid, the bubble-generating unit 130 will electrolyze the fluid to generate a bubble. With the hydrophobic design, the bubble is dissipated via the lateral exhaust hole but the fluid still remains within the flow path 115.

The definition of the first roughness factor ψ₁ and the second roughness factor ψ₂ of the surface of the second component 120 is based on the points disclosed in an essay “Engineering Surface Roughness To Manipulate Droplets In Micro-Fluidic Systems” (Ashutosh Shastry, etc, pp 694-697, 30 Jan.˜3 Feb., 2005, IEEE). This essay explains how the surface roughness is adjusted to change the hydrophilic/hydrophobic property between the droplets and the surface for manipulating the flow of droplets in micro-fluidic systems. According to the above essay, the surface roughness is changed when many micro silicon columns are created on a surface, and a roughness factor ψ is defined as the ratio of the surface area of silicon columns (the contact area between the silicon columns and the droplets) to the total planar area. Also, a roughness factor γ that further takes the area and the height of the silicon columns into consideration is provided in the essay. If the roughness of the surface changes, the contact angle and the capillary action between the droplets and the surface also change accordingly, such that the movability of the droplets on the surface changes.

Based on the above disclosure, a structural design of the second component 120 of the bubble micro-pump 1 of the first embodiment of the invention is illustrated in FIG. 2B. The first column group G1 and the second column group G2 both disposed on the surface of the second component 120 are respectively opposite the first area I and the second area II of the first component 110. The first column group G1 includes many first column elements 127 having the same cross-sectional area, and the second column group G2 includes many second column elements 129 having the same cross-sectional area. The first roughness factor ψ₁ is determined according to the ratio of the area of the first column group G1 to the first area I, and the second roughness factor 2 is determined according to the ratio of the area of the second column group G2 to the second area II. As the two roughness factors are different, according to the points disclosed by Ashutosh Shastry, the contact angle of the droplets in the first area I is different from that in the second area II, hence affecting the capillary action of the droplets. As a result, when the bubble in the fluid starts to vanish, the backfilling velocities of the fluid in the two areas are different.

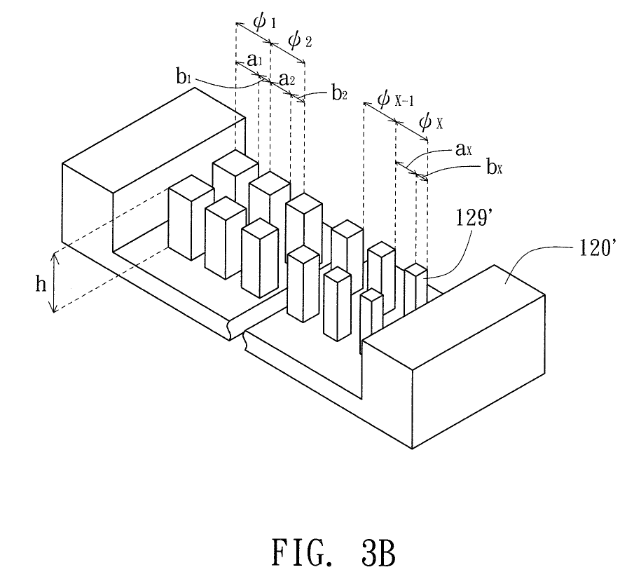

The roughness factor ψ preferably decreases or increases progressively such that a roughness gradient of the roughness factor ψ is generated. That is, the first roughness factor ψ₁ or the second roughness factor ψ₂ of the present embodiment of the invention decreases or increases progressively. More preferably, the cross-sectional areas of the column elements disposed on the second component 120 are different when the corresponding areas on the flow path 115 of the first component 110 are different, such that a surface roughness gradient exists on the surface of the second component 120. Referring to FIGS. 3A˜3B, two second perspectives of the second component of the bubble micro-pump of FIG. 1 are shown. As indicated in FIG. 3A, the column elements 129′ of the second component 120′ are sequentially disposed within the recess 125′ according to the size of the cross-sectional area, such that the surface of the second component 120′ has different roughness factors as the surface of the second component 120′ corresponds to different areas of the flow path 115. As indicated in FIG. 3B, the surface of the second component 120′ has different roughness factors ψᵢ (i=1˜x), and forms a surface roughness gradient (ψ₁>ψ₂> . . . >ψₓ). In the present embodiment of the invention, the height of the column elements 129′ is h. According to Ashutosh Shastry (2005), the roughness factor ψᵢ is expressed as: ψᵢ=bᵢ²/(aᵢ+bᵢ)²

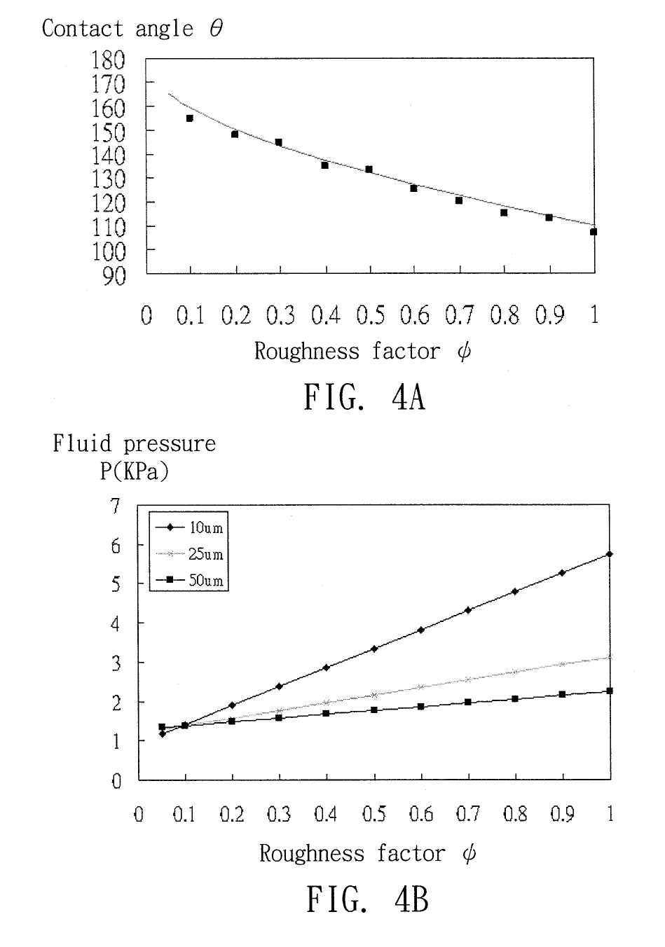

Referring to FIG. 4A, it is a diagram showing the relationship of roughness factor ψ and contact angle θ according to the Cassie-Baxter theory. As indicated in FIG. 4A, the larger the roughness factor ψ is, the smaller the contact angle θ of the fluid and the surface will be. The contact angle θ of the fluid and the surface affects the capillary action. As the contact angle θ is larger, the capillary action is smaller, hence affecting the backfilling velocity of the fluid. According to the fluid's capillary action on the surface of an object at the atmosphere pressure, as the contact angle θ becomes smaller (the roughness factor ψ becomes larger), the capillary action becomes larger and the fluid's backfilling velocity becomes faster. Referring to FIG. 4B, a diagram showing the relationship of roughness factor and fluid pressure is shown. As indicated in FIG. 4B, the fluid pressure P affected by the capillary action is proportional to the roughness factor ψ. Under different depths of the flow path (such as 10, 25, 50 μm) conditions, the shallower the flow path is, the larger the change in the fluid pressure P will be. That is, the capillary action becomes more evident. The thrust of the fluid is the difference between the corresponding fluid pressures of two different roughness factors. Presumably, the flow path has a depth of 10 μm, the thrust of the fluid between the roughness factor ψ0.2 and the roughness factor ψ0.8 is 3 kPa, that is, the difference between the corresponding fluid pressure 2 kPa and 5 kPa. Thus, by manipulating the depth of the flow path and gradient design of the roughness factor ψ, the thrust of the bubble micro-pump is determined.

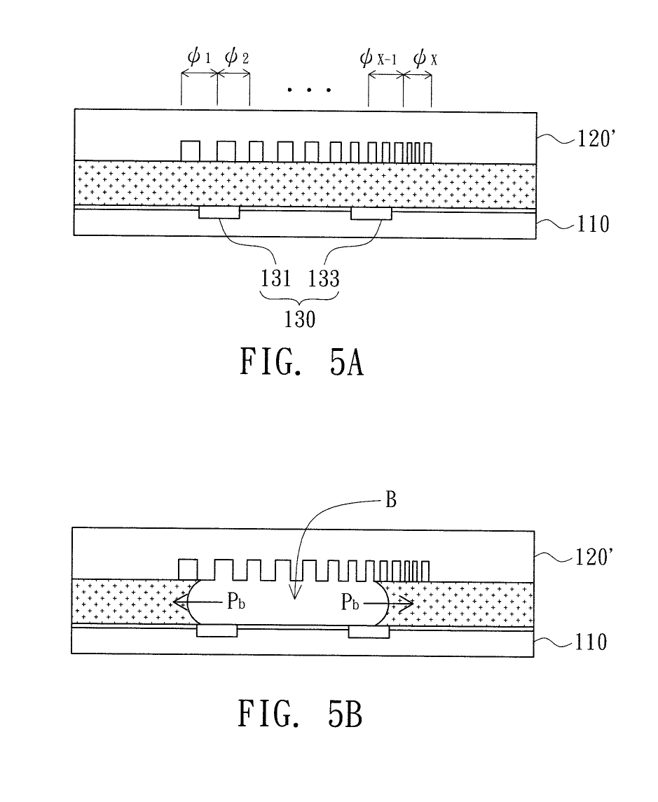

FIGS. 5A˜5D illustrate the operation of the bubble micro-pump 1. FIG. 5A is a cross-sectional view of the bubble micro-pump of FIG. 1. FIG. 5B˜5D are perspectives of the bubble micro-pump of FIG. 4B in continuous motion. The structure of the second component 120′ adopts the design disclosed in FIG. 3A. As indicated in FIGS. 5A˜5B, the first electrode 131 and the second electrode 133 of the bubble-generating unit 130 are respectively connected with the positive polarity and the negative polarity of the driving power (not shown). After the driving power is turned on, the first electrode 131 and the second electrode 133 start to electrolyze the fluid to generate bubbles. As indicated FIG. 5C, after a bubble B is generated and the driving power is turned off, the fluid surfaces on the two sides of the bubble B stay on the surfaces of different roughness factors, causing the contact angles θ_{L} and θ_{R} of the fluid and the second component 120′ to be different from each other. The surface of the first component 110 that contacts the fluid has the same property, thus generating the same contact angle θ_{b}. Due to the hydrophobic property of the surface on the second component 120′ and the setting that the roughness factor ψ₁ is larger than the roughness factor ψₓ (ψ₁>ψₓ), the relationship of the contact angles is expressed as: θ_{R}>θ_{L}>90 degrees. Thus, the relationship of the capillary action on the fluid is expressed as P_{L}>P_{R}, causing the fluid to have different backfilling velocities on two sides of the bubble B as indicated in FIG. 5D. During the continuous process of dissipating the bubble B and backfilling the fluid, the flow path 115 will have a rightward net fluid flow as if the fluid is pushed to the right by a pump.

The experimental results of the bubble micro-pump 1 according to the above theory are listed in Table 1.

TABLE 1

| | Roughness Gradient | |
|---|---|---|
| Micro-pump | Design ψᵢ (i = 1~8) | Depth h of Flow Path |
| No. 1 | 0.1, 0.2, 0.3, 0.4, 0.5, 0.6, 0.7, 1 | 20 μm |
| No. 2 | 0.1, 0.2, 0.3, 0.4, 0.5, 0.6, 0.7, 1 | 50 μm |

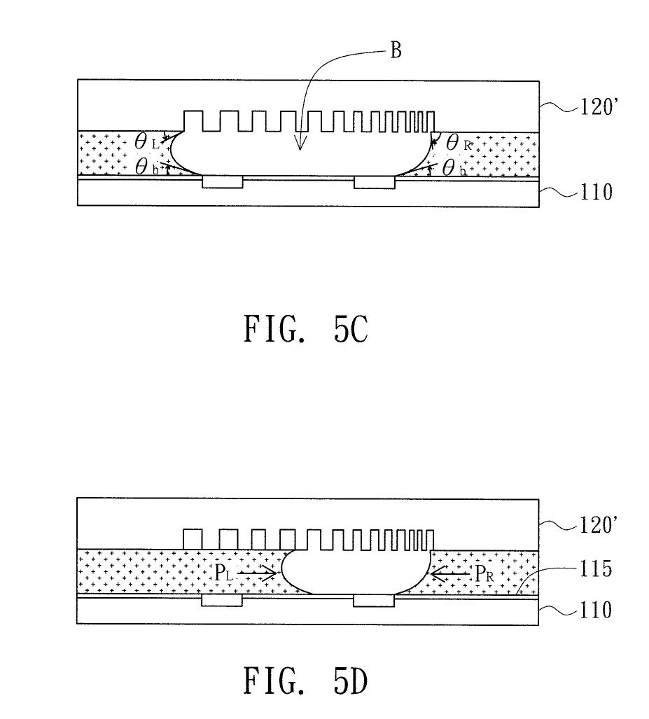

In the present embodiment of the invention, the specifications of the bubble micro-pump 1 during experiment are illustrated in Table 1, and referring to FIGS. 5A˜5D. During experiment, a de-ionized water solution is infused first, then a voltage is applied to the first electrode 131 and the second electrode 133 for electrolyzing the fluid to generate the bubble B. After the bubble B swells to a certain size, the bubble B is dissipated via the exhaust hole. During the process of dissipating the bubble B, the left-hand fluid, receiving a larger capillary action and having a faster backfilling velocity, generates a rightward net fluid flow. During the operation, the driving voltage connected with the first electrode 131 and the second electrode 133 is switched according to a particular frequency, and the repeated process of generating the bubble B by electrolyzing the fluid enables the fluid to be circulated, hence generating a continuous net fluid flow. Referring to FIG. 6, a diagram showing the relationship of voltage, frequency and flowing velocity according to the experimental results of the bubble micro-pump of FIG. 5A is shown. As indicated in FIG. 6, when the operating frequency and the driving voltage are increased, the flowing velocity of fluid is increased accordingly. Evidenced by the measuring results, the bubble micro-pump 1 can precisely control the velocity and the volume of fluid flow by manipulating the frequency and the intensity of the voltage applied thereto.

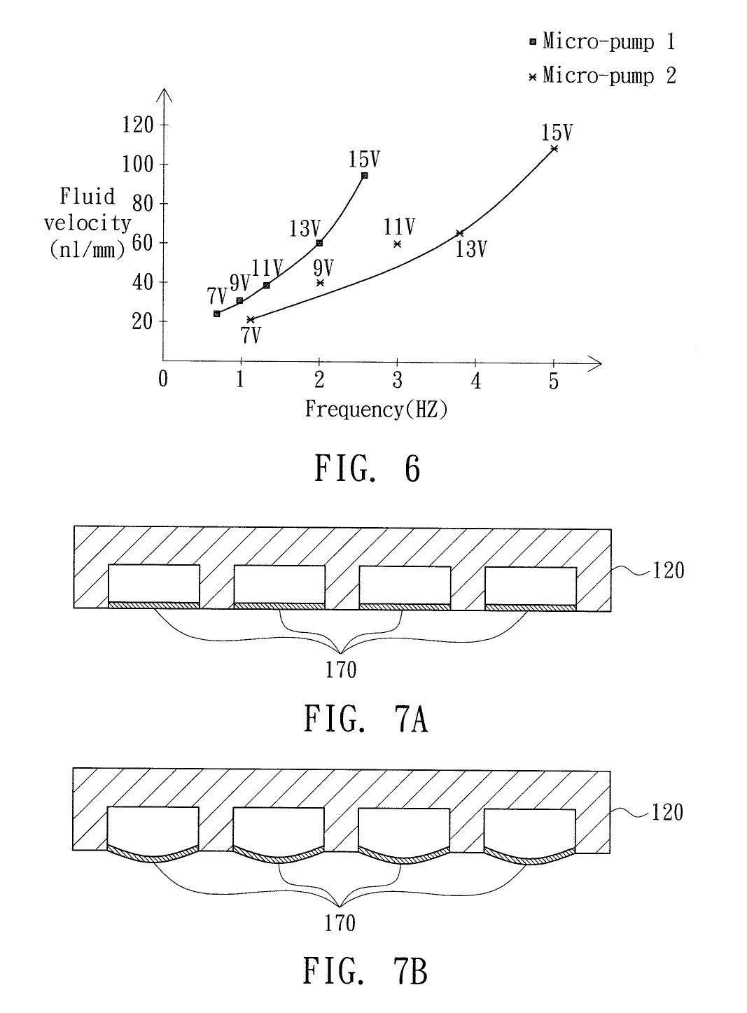

The second component 120 (120′) in the first embodiment of the invention is exemplified by column elements; however, the invention is not limited thereto. For example, each of the column elements of the present embodiment of the invention can be replaced with an adjustable membrane. Referring to FIGS. 7A˜7B, two perspectives showing the column elements of FIG. 2B formed by membranes are shown. The second component 120 has many adjustable membranes 170 disposed thereon. The membranes 170 at original state are illustrated in FIG. 7A. After the membranes 170 are driven, as indicated in FIG. 7B, the membranes 170 are deformed and the curvature of the membranes 170 is changed, such that the contact area between the second component 120 and the fluid changes accordingly. The membranes 170 can be driven by using a fluid or an air for pushing the membranes 170 or applying a voltage to the membranes 170 for changing the deformation of the membranes 170. More information regarding the deformable membrane is disclosed in U.S. Pat. No. 6,929,030, “Mmicrofabricated Elastomeric Valve and Pump System”.

In the first embodiment, the surface roughness of the second component 120 is adjusted by changing the contact area between the column elements and the fluid. In other embodiments, the roughness factor can be controlled by means of adjusting the height of the column elements as well. The surface roughness gradient can be formed for driving the fluid through the arrangement of the size and the gap of the column elements. Therefore, the bubble micro-pump of the first embodiment of the invention has the advantages of simple manufacturing process and easy operation.

Although the bubble-generating unit 130 of the first embodiment generates the bubbles by electrolyzing the fluid, the invention is not limited thereto. Any ways of generating a bubble in a fluid such as generating a bubble by heating the fluid are still within the scope of the technology of the invention.

In the first embodiment, the bubble-generating unit 130 is, for example, an electrode set. In other embodiments, two or more than two electrode sets can be disposed on the flow path 115 of the first component 110. Such method provides the user with a function of setting the position of generating the bubble. The user can select a corresponding electrode set for electrolyzing the fluid to generate the bubble. Thus, not only the number of bubbles relating to the frequency of the driving power can be determined, the flowing velocity of the driving fluid can be switched while incorporating with setting the position of generating the bubbles.

The bubble micro-pump provided in the first embodiment of the invention is widely used in various micro-fluidic systems such as biomedical chip and micro-fuel cell for driving various fluids to flow. The bubble micro-pump has the advantages of low power-consumption, low driving voltage, low operating temperature and low bubble-forming pressure, which is ideal for driving the fluid. A number of embodiments are further disclosed below for elaborating the application of the bubble micro-pump of the first embodiment but not for limiting the scope of application of the invention.

### Second Embodiment

The second embodiment provides a two-way fluid-driving device that controls the flowing direction of the fluid through the use of different flow paths.

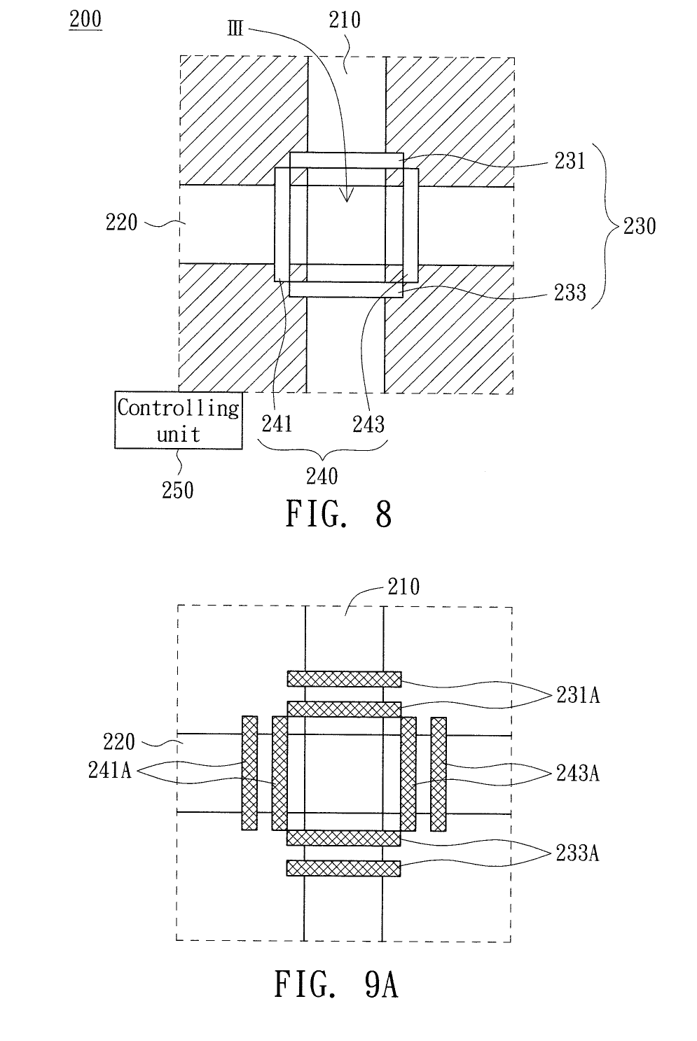

Referring to FIG. 8, a perspective of a two-way fluid-driving device according to the second embodiment of the invention is shown. As indicated in FIG. 8, the two-way fluid-driving device 200 includes a first primary flow path 210, a second primary flow path 220, a first driving portion 230, a second driving portion 240 and a controlling unit 250. The first primary flow path 210 and the second primary flow path 220 are alternately disposed to form a common flow path area II. The first driving portion 230 disposed on the first primary flow path 210 is adjacent to the common flow path area III, and the second driving portion 240 disposed on the second primary flow path 220 is also adjacent to the common flow path area III. The first driving portion 230 and the second driving portion 240 are driven by the bubble micro-pump of the first embodiment for example. The first driving portion 230 and the second driving portion 240 both include at least a bubble micro-pump. However, in the second embodiment of the invention, the first driving portion 230 and the second driving portion 240 both include two bubble micro-pumps. Preferably, each bubble micro-pump is disposed next to the common flow path area III, and the bubble micro-pumps of the same driving portion are symmetrically disposed on two opposite sides of the common flow path area III. The controlling unit 250 is electrically connected with the bubble micro-pumps 231 and 233 of the first driving portion 230 as well as the bubble micro-pumps 241 and 243 of the second driving portion 240 respectively. When the controlling unit 250 drives the bubble micro-pumps 231 and 233 of the first driving portion 230 to function, the first driving portion 230 pushes the fluid on the first primary flow path 210 to flow. When the controlling unit 250 drives the bubble micro-pumps 241 and 243 of the second driving portion 240 to function, the second driving portion 240 pushes the fluid on the second primary flow path 220 to flow.

The flowing direction of the fluid has much to do with the design of the flow path. For example, the first primary flow path 210 is perpendicular to the second primary flow path 220, such that the fluid flows along two criss-crossed directions. Preferably, the two-way fluid driving device 200 is constituted by a top component and a bottom component, wherein the top component has roughness surface, and the bottom component has the first primary flow path 210, the second primary flow path 220 and the electrode sets. The two-way fluid-driving device 200 is further elaborated below by accompanying drawings.

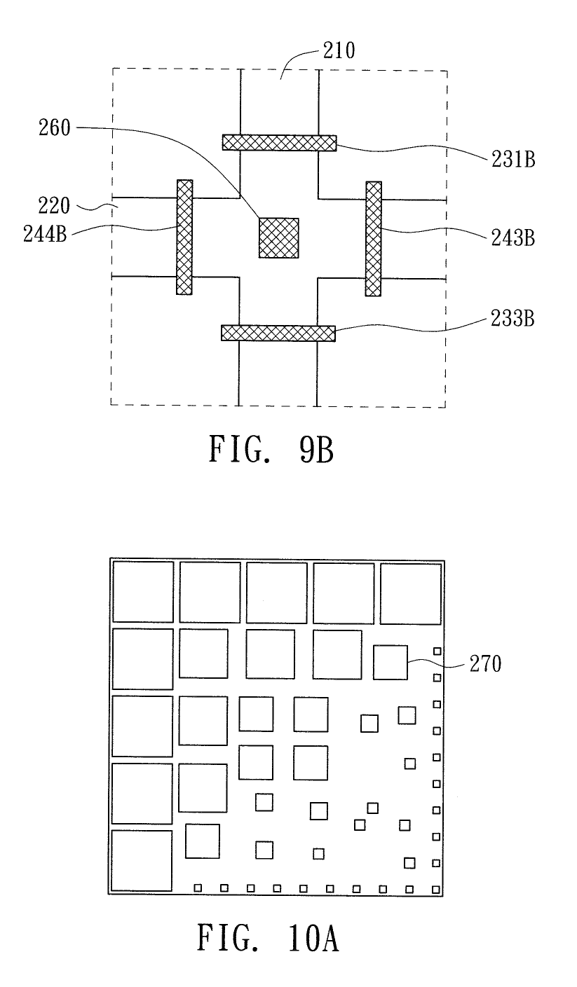

Referring to FIG. 9A˜9B, a first and a second perspectives of a bottom component of the two-way fluid-driving device of FIG. 8 are shown. The first driving portion 230 and the second driving portion 240 are constituted by the bubble micro-pumps 231 and 233 and the bubble micro-pumps 241 and 243 respectively. Totally, there are four electrode sets disposed on the first primary flow path 210 and the second primary flow path 220. As indicated in FIG. 9A, the electrode sets 231A and 233A of the first driving portion 230 as well as the electrode sets 241A and 243A of the second driving portion 240 are disposed on the four sides of the common flow path area III. To drive the fluid on the first primary flow path 210 to flow, the electrode sets 231A and 233A (four electrodes in total) dispsoed on the first primary flow path 210 are turned on. To drive the fluid on the second primary flow path 220 to flow, the electrode sets 241A and 243A dispsoed on the second primary flow path 210 are turned on. A simplified design of electrode set is shown in FIG. 9B. Each of the primary flow paths 210 and 220 seems to have three electrodes, but one of the electrodes is disposed in the common flow path area III and is used by both the first primary flow path 210 and the second primary flow path 220 at the same time. Compared with the design of FIG. 9A that uses four electrodes for driving the fluid to flow, each of the primary flow paths 210 and 220 in FIG. 9B uses only three electrodes (231B, 233B and 260; or 241B, 243B and 260).

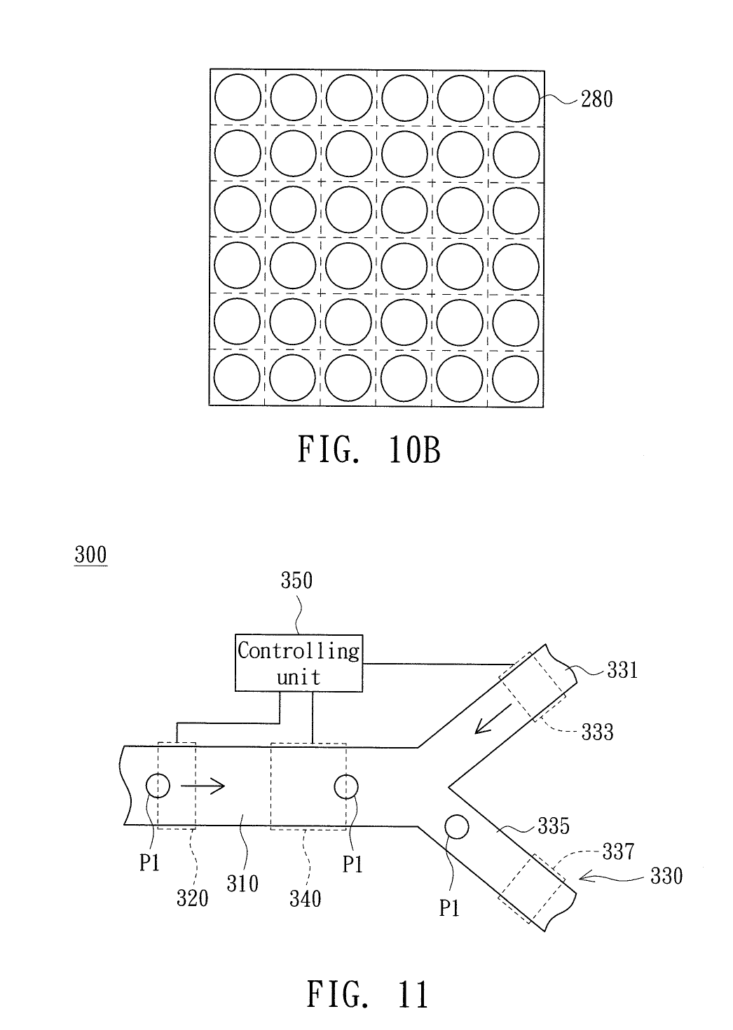

Referring to FIGS. 10A˜10B, a first and a second perspectives of a top component of the two-way fluid-driving device of FIG. 8 are shown. As indicated in FIG. 10A, to incorporate the criss-crossed design of the first primary flow path 210 and the second primary flow path 220, the column elements 270 disposed on the surface of the component form a roughness gradient in the oblique direction and a roughness gradient in the rightward direction as well. That is, the column elements 270 having different cross-sectional areas are symmetric to a diagonal line at 45 degrees. Thus, the roughness gradients are generated in more than two directions, such that the backfilling velocities of the fluid at the left and at the top are faster than the backfilling velocities of the fluid in the right and at the bottom. Moreover, as indicated in FIG. 10B, many adjustable membranes 280 are arranged in a matrix. When the roughness gradient is to be changed, only the membranes within a particular area are driven. The roughness gradient can be changed in multi-directions and in different positions as well. The driving of the membranes has been elaborated in the first embodiment with the accompanying drawings of FIGS. 7A˜7B.

### Third Embodiment

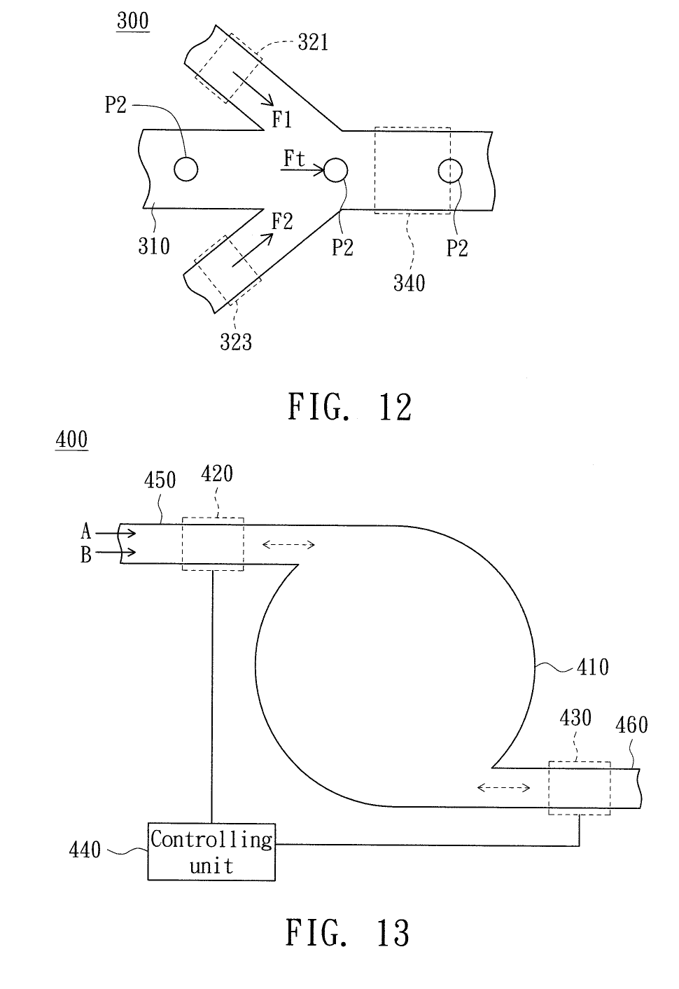

Referring to FIG. 11, a first perspective of a particle-sorting device according to a third embodiment of the invention is shown. As indicated in FIG. 11, the particle-sorting device 300 includes a primary flow path 310, a driving portion 320, a diversion portion 330, a detecting unit 340 and a controlling unit 350. The driving portion 320 is disposed at the front part of the primary flow path 310. The diversion portion 330 includes a first branch flow path 331 and a second branch flow path 335, and is connected with the rear part of the primary flow path 310. A bubble micro-pump 333 similar to the micro-pump 1 of the first embodiment is disposed on the first branch flow path 331, and a bubble micro-pump 337 is disposed on the second branch flow path 335. The detecting unit 340 disposed on primary flow path 310 is located between the driving portion 320 and the diversion portion 330. The controlling unit 350 is electrically connected with the driving portion 320, the bubble micro-pumps 333, 337, and the detecting unit 340. When the driving portion 320 is functioned to push a fluid carrying particles P1 of the primary flow path 310 to flow for enabling the particles P1 to pass the detecting unit 340 to complete the recognition of the particles P1, the detecting unit 340 transmits a signal to the controlling unit 350 for driving the bubble micro-pumps 333 or 337 of the diversion portion 330 to function, such that the particles P1 move to the first branch flow path 331 or the second branch flow path 335 along with the fluid.

The driving portion 320 of the primary flow path 310 includes at least a bubble micro-pump providing sufficient thrust for driving the fluid after the particles P1 enter the primary flow path 310. The number of bubble micro-pumps depends on the length of the primary flow path 310. When the particles P1 move rightward along the primary flow path 310 and enter the sensing area of the detecting unit 340, the detecting unit 340 will detect particular property of the particles P1 such as the electrical property or the volume. The detecting unit 340 exemplified by a photo sensor or an electro sensor is electrically connected with the controlling unit 350. After the detecting unit 340 recognizes the particles P1, the detecting unit 340 transmits a signal for the controlling unit 350 to determine whether to activate the sorting mechanism or not. When the sorting mechanism is activated, the bubble micro-pump 333 or 337 of the diversion portion 330 starts to function and electrolyze the fluid to generate bubbles, such that the fluid on the first branch flow path 331 or the second branch flow path 335 starts to flow. Assume that the particles P1 of the present embodiment of the invention enter the second branch flow path 335 after the detection process. Both the primary flow path 310 and the first branch flow path 331 can generate a thrust for driving the fluid. When the bubble micro-pump 333 on the first branch flow path 331 drives the fluid to flow along the direction indicated by an arrow, a right-downward net thrust enables the particles P1 to enter the second branch flow path 335 such that the sorting function is completed.

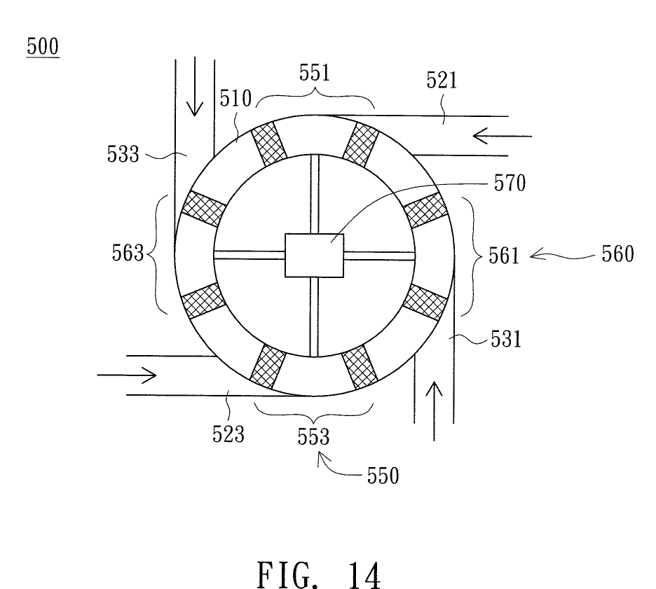

The design of driving the particles to enter the sorting mechanism is disclosed in FIG. 12, a second perspective of a particle-sorting device according to the third embodiment of the invention. As indicated in FIG. 12, the driving portion 320 of the particle-sorting device 300 includes two bubble micro-pumps 321 and 323, wherein the two bubble micro-pumps 321 and 323 are preferably disposed on two opposite sides of the primary flow path 310 symmetrically. When the two bubble micro-pumps 321 and 323 of the driving portion 320 start to drive the fluid to flow, a tilting driving force is applied to the particles P2. Preferably, the magnitudes of the driving forces F1 and F2 are similar, such that the two forces F1 and F2 will form a resultant force Ft similar to hydrodynamic focusing for enabling the particles P2 to proceed in order. After the detecting unit 340 completes the recognition of the particles P2, the bubble micro-pump 333 or the bubble micro-pump 337 in FIG. 11 is activated for guiding the particles P2 to enter the first branch flow path 331 or the second branch flow path 335, such that the sorting and collection of the particles are completed.

### Fourth Embodiment

In the fourth embodiment of the invention, a fluid-mixing device is provided. The fluid-mixing device drives the fluid to move reciprocally by a bubble micro-pump of the first embodiment such that the fluid is mixed.

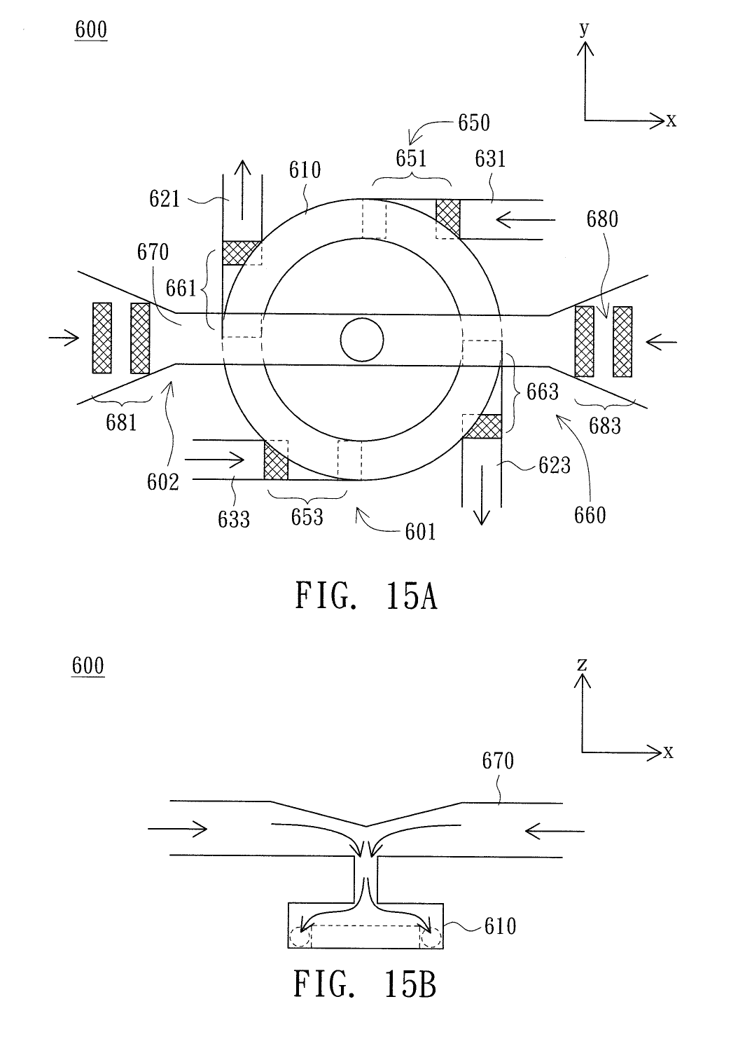

Referring to FIG. 13, a perspective of a fluid-mixing device according to a fourth embodiment of the invention is shown. As indicated in FIG. 13, the fluid-mixing device 400 includes a mixing chamber 410, a first driving portion 420, a second driving portion 430 and a controlling unit 440. The mixing chamber 410 has an inlet flow path 450 and an outlet flow path 460. The first driving portion 420 is disposed on the inlet flow path 450, and the second driving portion 430 is disposed on the outlet flow path 460, wherein each of the first driving portion 420 and the second driving portion 430 includes at least a bubble micro-pump of the first embodiment. The controlling unit 440 is electrically connected with the bubble micro-pumps of the first driving portion 420 and the second driving portion 430. After the controlling unit 440 drives the first driving portion 420 for introducing at least two non-mixed fluids A and B into the mixing chamber 410 via the inlet flow path 450, the controlling unit 440 then alternately drives the second driving portion 430 and the first driving portion 420 to function for repeatedly guiding the two fluids to enter the mixing chamber 410 via the inlet flow path 450 and leave the mixing chamber 410 via the outlet flow path 460, such that the two fluids are mixed.

For example, the first driving portion 420 introduces two layers of non-mixed fluids A and B into the mixing chamber 410 in the form of layer flow via the inlet flow path 450. Next, after the controlling unit 440 drives the bubble micro-pump of the first driving portion 420 to push the fluid rightward and drives the bubble micro-pump of the second driving portion 430 to push the fluid leftward for a number of repetitions, the fluids A and B will be completely mixed in the mixing chamber 410. After the fluids A and B are mixed, the first driving portion 420 is turned off and only the second driving portion 430 remains on, then the mixed fluid is sent to the subsequent processing unit via the outlet flow path 460.

Preferably, the mixing chamber 410 is made from a transparent material, such that the reaction of medical or biochemical test in the fluid-mixing device 400 can be observed. Besides, during the process of electrolyzing the fluid to generate bubbles, only a tiny amount of fluid is consumed, and the concentration of the fluid will not change dramatically.

### Fifth Embodiment

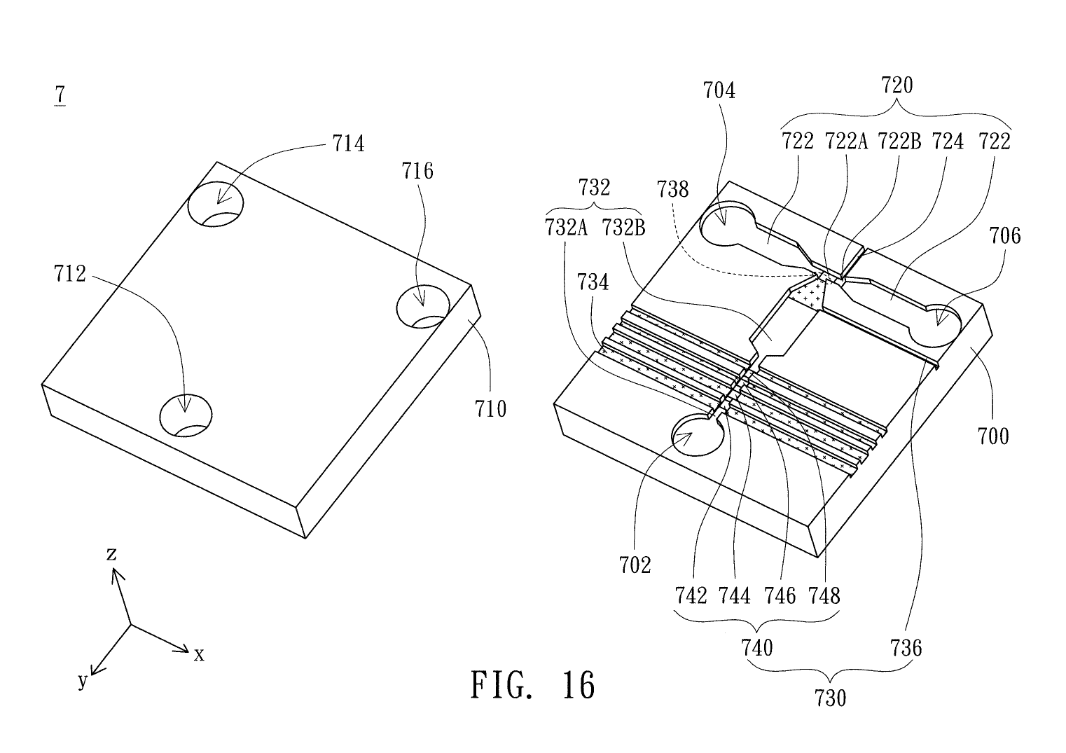

Referring to FIG. 14, a perspective of a ring-shaped fluid-mixing device according to a fifth embodiment of the invention is shown. As indicated in FIG. 14, the ring-shaped fluid-mixing device 500 includes a ring-shaped primary flow path 510, two first branch flow paths 521 and 523, two second branch flow paths 531 and 533, a first driving portion 550, a second driving portion 560, and a controlling unit (not illustrated). Both the first branch flow paths 521 and 523 and the second branch flow paths 531 and 533 are connected with the ring-shaped primary flow path 510, wherein the second branch flow paths 531 and 533 are disposed alternately with the first branch flow paths 521 and 523. The first driving portion 550 and the second driving portion 560 use the bubble micro-pump design as disclosed in the first embodiment. Two bubble micro-pumps 551 and 553 of the first driving portion 550 are disposed on the ring-shaped primary flow path 510 and individually adjacent to the first branch flow paths 521 and 523. Two bubble micro-pumps 561 and 563 of the second driving portion 560 are also disposed on the ring-shaped primary flow path 510 and individually adjacent to the second branch flow paths 531 and 533. The controlling unit (not illustrated) is electrically connected with the bubble micro-pumps 551 and 553 of the first driving portion 550 as well as the bubble micro-pumps 561 and 563 of the second driving portion 560. After different fluids are introduced into the ring-shaped primary flow path 510 via the first branch flow paths 521 and 523 as well as the second branch flow paths 531 and 533, the controlling unit alternately drives the first driving portion 550 and the second driving portion 560, such that different fluids are mixed in the ring-shaped primary flow path 510. The air of the bubble generated when electrolyzing the fluid is dissipated from the device via a common exhaust hole 570.

Preferably, the bubble micro-pumps 551 and 553 of the first driving portion 550 as well as the bubble micro-pumps 561 and 563 of the second driving portion 560 generate two opposite driving forces. For example, the first driving portion 550 drives the fluid to flow counterclockwisely, and the second driving portion 560 drives the fluid to flow clockwisely. After the controlling unit alternately drives the bubble micro-pumps 551, 553, 561 and 563 for enabling the fluid to flow reciprocally, different fluids are completely mixed in the ring-shaped primary flow path 510.

### Sixth Embodiment

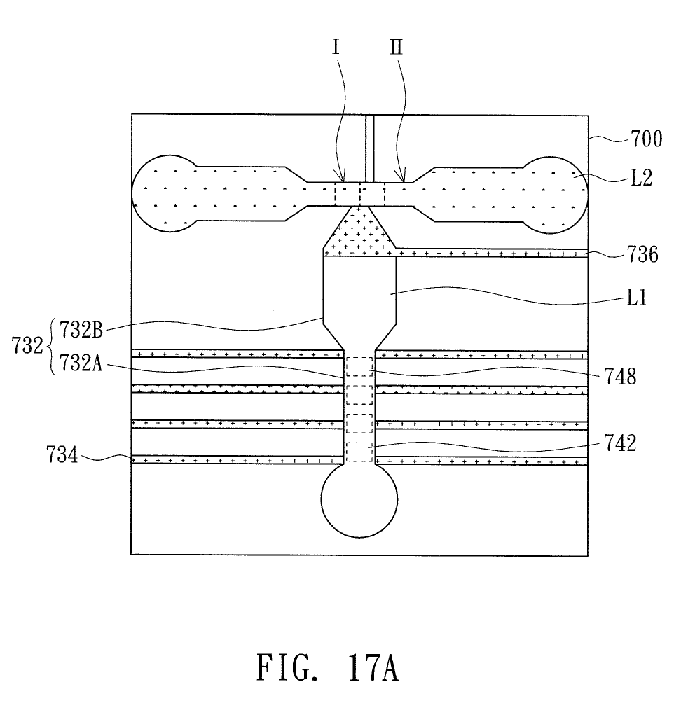

Referring to FIGS. 15A˜15B, FIG. 15A is a top view of a compound-type fluid-mixing device according to a sixth embodiment of the invention, and FIG. 15B is a side view of the compound-type fluid-mixing device of FIG. 15A. As indicated in FIG. 15A, the compound-type fluid-mixing device 600 includes a first flow path component 601, a second flow path component 602 and a controlling unit (not shown). The first flow path component 601 includes a ring-shaped primary flow path 610, two outlet flow paths 621 and 623, two inlet flow paths 631 and 633, a first driving portion 650 and a second driving portion 660. The outlet flow paths 621 and 623 and the inlet flow paths 631 and 633 are connected with the ring-shaped primary flow path 610. The first driving portion 650 is disposed at the junction of the ring-shaped primary flow path 610 and the inlet flow path, and the second driving portion 660 is disposed at the junction of the ring-shaped primary flow path 610 and the outlet flow path. Each of the first driving portion 650 and the second driving portion 660 includes two bubble micro-pumps (designated as 651, 653, 661, 663 in the diagram) as disclosed in the first embodiment, wherein the bubble micro-pumps are disposed at the junctions of the ring-shaped primary flow path 610 and each of the outlet flow paths 621 and 623 and each of the inlet flow paths 631 and 633. Preferably, the outlet flow paths 621 and 623 and the inlet flow paths 631 and 633 are separated by 90 degrees.

The second flow path component 602 is disposed above the first flow path component 601 as indicated in FIG. 15B. The second flow path component 602 includes a direct flow path 670 and a third driving portion 680, wherein the direct flow path 670 is connected with the ring-shaped primary flow path 610. The third driving portion 680 includes at least two bubble micro-pumps 681 and 683. The bubble micro-pumps 681 and 683 are respectively disposed on the two opposite sides of the junction of the direct flow path 670 and the ring-shaped primary flow path 610. The controlling unit is electrically connected with the bubble micro-pumps of the first driving portion 650, the second driving portion 660 and the third driving portion 680 respectively. After the controlling unit drives the first driving portion 650 for introducing a fluid into the ring-shaped primary flow path 610 via the inlet flow paths 631 and 633 and drives the third driving portion 680 to introduce another fluid into the ring-shaped primary flow path 610 via two sides of the direct flow path 670, the controlling unit alternately drives the first driving portion 650 and the second driving portion 660, such that the above two fluids flow reciprocally and are mixed in the ring-shaped primary flow path 610. After the fluids are mixed, the mixed fluid is driven by the second driving portion 660 to leave the ring-shaped primary flow path 610 via the outlet flow paths 621 and 623.

In the present embodiment of the invention, the first flow path component 601 is exemplified by two outlet flow paths 621 and 623 as well as two inlet flow paths 631 and 633. However, in other embodiments, an outlet flow path and an inlet flow path would suffice to facilitate the mixing of fluids by use of a bubble micro-pump on the outlet flow path and another one on the inlet flow path.

### Seventh Embodiment

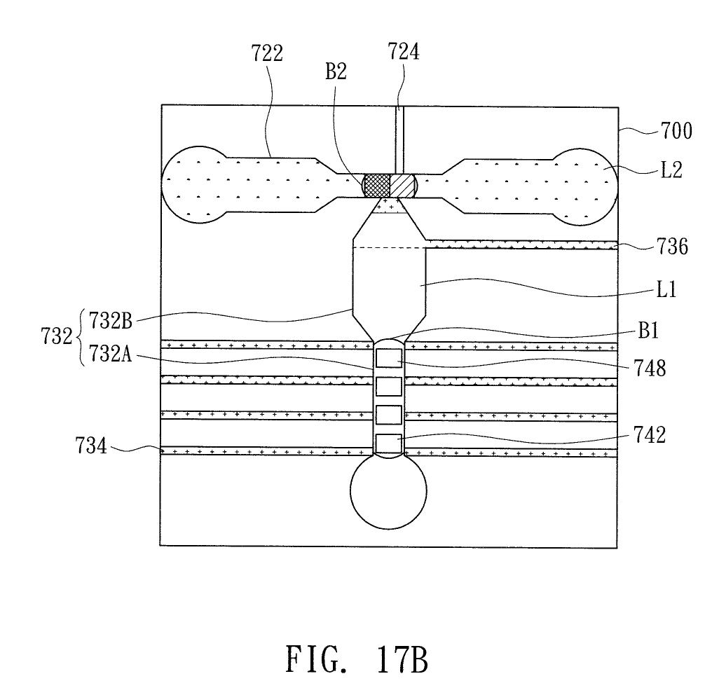

Referring to FIG. 16, an exploded diagram of a bubble micro-pump according to a seventh embodiment of the invention is shown. As indicated in FIG. 16, the bubble micro-pump 7 includes a substrate 700 and a cover 710. A main component 720 and a driving portion are positioned on the substrate 700. The main component 720 includes a primary flow path 722 and a lateral air exhaust channel 724, wherein the lateral air exhaust channel 724 is connected with the primary flow path 722. The primary flow path 722 has a first surface 722A and a second surface 722B located in a first area and a second area of the primary flow path 722, respectively. The first area and the second area (not shown in FIG. 16) are adjacent to the lateral air exhaust channel 724, and the hydrophilic/hydrophobic property of the first surface 722A is different from that of the second surface 722B. The driving portion includes an indirect bubble-generating device 730. A secondary flow path 732 of the indirect bubble-generating device 730 is connected with the primary flow path 722 of the main component 720. The indirect bubble-generating device 730 generates bubbles around the first area and the second area. When the bubbles start to vanish via the lateral air exhaust channel 724, the backfilling velocity of the fluid in the first area is different from that of the second area due to the different hydrophilic/hydrophobic properties of the first surface 722A and the second surface 722B, such that the fluid is driven to flow.

The cover 710 of the bubble micro-pump 7 is disposed on the substrate 700. Preferably, the cover 710 is made from a transparent material, such that the fluid flow on the substrate 700 can be clearly observed when the bubble micro-pump 7 functions. For example, the cover 710 is made from polydimethylsioxane (PDMS) or glass. Furthermore, in the present embodiment of the invention, the cover 710 has a first inlet hole 712, a second inlet hole 714 and an outlet hole 716 via which the fluid enters and leaves the substrate 100. However, the invention is not limited thereto.

On the substrate 700, the hydrophilic/hydrophobic properties of the first surface 722A and the second surface 722B can be achieved by at least two methods. According to the first method, the first surface 122A is a roughness surface having a first roughness factor ψ₁, and the second surface 122B is a roughness surface having a second roughness factor ψ₂. The hydrophilic/hydrophobic property between the droplets and the surface changes as the roughness of the surface is adjusted, thereby controlling the flow of the droplets in the micro-fluidic systems. Therefore, the magnitude of the first roughness factor ψ₁ of the first surface 122A and the magnitude of the second roughness factor ψ₂ of the second surface 122B have much to do with the contact areas between the fluid and the first surface 122A and the second surface 122B. In the present embodiment of the invention, many micro-silicon columns are created on the surface for changing the surface roughness, wherein the roughness factor ψ is defined as “the ratio of the surface area (the contact area with the droplets) of the silicon column to the total area of the surface”. As the surface roughness changes, the contact angle as well as the capillary action between the droplets and the surface will change accordingly, such that the mobility of the droplets on the surface also changes.

The roughness factor of the roughness surface has much to do with the contact angle between the fluid and the surface. The larger the roughness factor of the surface is, the smaller the contact angle will be. The contact angle between the fluid and the surface affects the magnitude of the capillary action and further affects the backfilling velocity of the fluid when the bubble vanishes, wherein the larger the capillary action is, the faster the backfilling velocity of the fluid will be. At an atmosphere pressure, When the contact angle is smaller (the roughness factor becomes larger), the larger the capillary action will be, and the backfilling velocity of the fluid becomes faster.

According to the second method, the property of the first surface 722A is determined by a hydrophobic material disposed on the first surface 722A of the main component 720. And the property of the second surface 722B is determined by a hydrophilic material disposed on the second surface 722B. The hydrophilic material and the hydrophobic material have different action forces on the droplets, wherein the capillary action of the hydrophobic material to the droplets is greater than the capillary action of the hydrophilic material to the droplets, such that the action forces of the hydrophobic material and the hydrophilic material to the droplets are similar to the surface roughness disclosed above. Therefore, the design of the hydrophilic material and the hydrophobic material can be used to control the flow of the droplets in micro-fluidic system.

In the present embodiment of the invention, the first surface 722A within the first area of the primary flow path 722 is made from a hydrophobic material, and the second surface 722B within the second area is made from a hydrophilic material. The hydrophobic material and the hydrophilic material can be manufactured on the primary flow path 722 after the primary flow path 722 is formed. Or, the hydrophobic material on the first surface 722A and the hydrophilic material on the second surface 722B are manufactured concurrent with the manufacturing process of the primary flow path 722.

Due to the hydrophobic property of the first surface 722A and the hydrophilic property of the second surface 722B, the backfilling velocity of the fluid in the first area is faster than that in the second area, such that a net fluid flow is generated along the direction x of the diagram.

Preferably, the substrate 700 has a hydrophobic material on the lateral air exhaust channel 724 for avoiding the fluid leaking out of the substrate 700 via the lateral air exhaust channel 724. Examples of the hydrophobic material include Teflon, and examples of the hydrophilic material include glass, silicon dioxide and so on. The substrate 700 further includes a first fluid inlet 702, a second fluid inlet 704 and a fluid outlet 706. The first fluid inlet 702 is located at the front end of the secondary flow path 732 and opposite the first inlet hole 712 of the cover 710. The second fluid inlet 704 is adjacent to the primary flow path 722 and opposite the second inlet hole 714 of the cover 710. The fluid outlet 706 is also adjacent to the primary flow path 722 but opposite the outlet hole 716 of the cover 710. The first surface 722A, the second surface 722B and the lateral air exhaust channel 724 are positioned in the middle of the primary flow path 722.

As shown in FIG. 16, in the present embodiment of the invention, the indirect bubble-generating device 730 includes a secondary flow path 732, at least an air exhaust channel 734, an air intake channel 736, a bubble outlet 738 and a bubble-generating element 740. The present embodiment of the invention is exemplified by a number of air exhaust channels 734 connected with the front part 732A of the secondary flow path, wherein the air exhaust channels 734 facilitate the air to be dissipated from the substrate 700. The air intake channel 736 is connected with the rear part 732B of the secondary flow path 732, wherein the air intake channel 736 guides air to be taken in and filled in part of the rear part 732B of the secondary flow path. The bubble outlet 738 is disposed at a terminal of the secondary flow path 732 and around the first area and the second area on the primary flow path 722. Of the substrate 700, hydrophobic material is disposed on the air exhaust channel 734, the air intake channel 736 and a part of the rear part 732B of the secondary flow path for avoiding the fluid leaking out of the substrate 700 via the air exhaust channel 734, the air intake channel 736 and the rear part 732B of the secondary flow path. The hydrophobic material is Teflon for example. The width of the front part 732A of the secondary flow path is substantially different from that of the rear part 732B of the secondary flow path. In the present embodiment of the invention, the width of the front part 732A of the secondary flow path is smaller than that of the rear part 732B of the secondary flow path, wherein the width of a part of the rear part 732B of the secondary flow path connected with the primary flow path 722 is narrowed down to the width of the bubble outlet 738.

Preferably, the fluid on the secondary flow path 732 of the indirect bubble-generating device 730 is an electrolytic solution or a de-ionized solution. The bubble-generating element 740 is disposed at the front part 732A of the secondary flow path 732 and electrically connected with a driving power (not illustrated). The bubble-generating element 740 is used for electrolyzing the fluid at the front part 732A of the secondary flow path 732 to generate bubbles. The bubble-generating element 740 includes at least an electrode set. In the present embodiment of the invention, the electrode set includes four electrodes 742, 744, 746 and 748. Each of the electrodes 742, 744, 746 and 748 is electrically connected with the driving power. The driving power provides a voltage to each of the electrodes 742, 744, 746 and 748, and timely adjusts the locations and polarities of the driving electrodes. The electrodes 742, 744, 746 and 748 are made from metal, and preferably made from a passive metal such as gold or platinum possessing an inactive property. Any two electrodes on the front part 732A of the secondary flow path are driven according to the needs, and the location and the size of the bubble can be pre-determined.

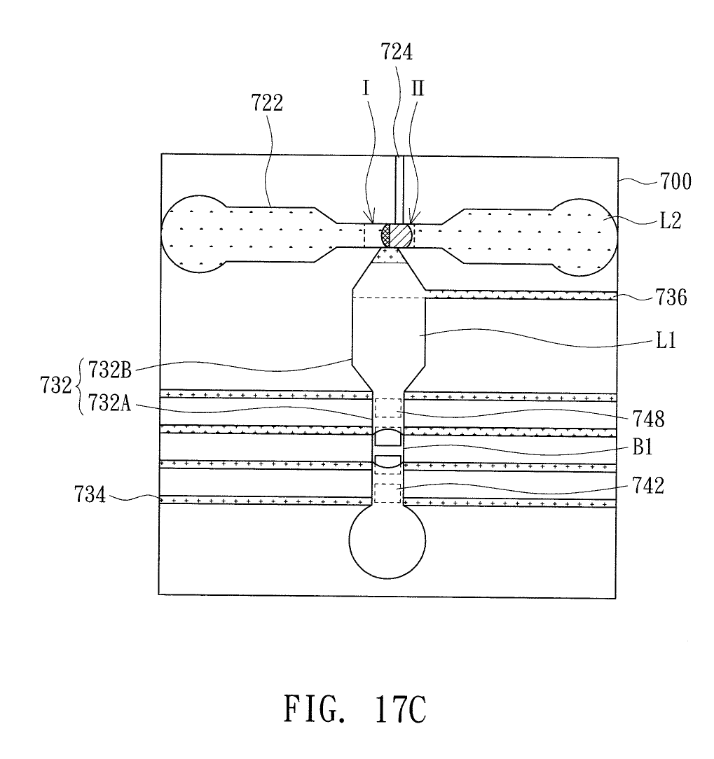

Referring to FIG. 17A˜17C, perspectives of the bubble micro-pump of FIG. 16 in continuous motion are shown. As indicated in FIG. 17A, when the fluid L1 enters the secondary flow path 732 via the first inlet hole 712 of the cover 710 (refer to FIG. 16) and the first fluid inlet 702 of the substrate 700, since the hydrophobic material is disposed on the air exhaust channel 734, the air intake channel 736, and a part of the rear part 732B of the secondary flow path, the fluid L1 remains on the secondary flow path 732, and the part of the rear part 732B of the secondary flow path 732 having a hydrophobic material will be filled with air. The fluid L2 enters the primary flow path 722 via the second inlet hole 714 of the cover 710 and the second fluid inlet 702 of the substrate 700.

When voltages are applied to the electrodes 742 and 748 and enable the electrodes 742 and 748 to have opposite polarities, the electrodes 742 and 748 start to electrolyze the fluid L1 for generating a bubble B1 as indicated in FIG. 17B. When the bubble B1 swells, the fluid on the rear part 732B of the secondary flow path 732 is pushed toward the terminal of the flow path 732 such that the air on the rear part 732B of the secondary flow path 732 is squeezed out of the secondary flow path 732 and a bubble B2 is generated in the fluid L2 on the primary flow path 722. When the bubble B2 swells to a certain size, the bubble B2 is dissipated via the lateral air exhaust channel 724.

As indicated in FIG. 17C, when the bubble B2 is dissipated via the lateral air exhaust channel 724, as the hydrophilic/hydrophobic property of the surface in the first area I is different from that of the surface in the second area II, the left-hand side fluid on the primary flow path 722 receives a larger capillary action and has a faster backfilling velocity than the right-hand fluid on the primary flow path 722. As a result, the fluid L2 has a rightward net flow.

When the bubble B1 vanishes from the air exhaust channel 734 and the fluid L1 on the front part 732A of the secondary flow path 732 backfills, the fluid on the rear part 732B of the secondary flow path 732 backfills to the front part 732A of the secondary flow path 732. Meanwhile, the rear part 732B of the secondary flow path 732 will generate a vacuum-like suction force pulling in the external air inside the rear part 732B of the flow path 732 via the air intake channel 736, such that the air is again filled in part of the rear part 732B. The complete cycle of electrolyzing begins at applying the voltages to the electrodes 742 and 748 for electrolyzing the fluid to generate the bubble B1, turning off the voltages applied to the electrodes 742 and 748, and ends at dissipating the bubble B1 and the bubble B2 via the air exhaust channel 734 and the lateral air exhaust channel 724 respectively and backfilling the fluid.

During the repeated process of electrolyzing the fluid to generate the bubbles B1 and B2, the fluid is circulated and a continuous net fluid flow is generated. The bubble micro-pump 7 can control the velocity and volume of flow precisely by using different driving voltages and operating frequencies. Besides, the function of the bubble micro-pump 7 also depends on the size of the cross-sectional area of the flow path.

The bubble micro-pump 7 drives the fluid L2 by way of filling the bubble B2 formed by the external air to the rear part 732B of the secondary flow path 732 and is not affected by the bubble B1. That is, although the pH value of the fluid L1 changes during the process of electrolyzing, the fluid L1 will not directly affect the pH value of the fluid L2. Thus, when applying the bubble micro-pump 7 to drive other types of fluid, the pH value of the fluid will not affect the micro-flow path system (such as biomedical chip) of the subsequent processing fluid.

According to the substrate 700 of the present embodiment of the invention, the hydrophobic material and the hydrophilic material are respectively disposed on the first area I (or the first surface 722A as indicated in FIG. 16) and the second area II (or the second surface 722B as indicated in FIG. 16). However, in other embodiments, as long as the hydrophilic/hydrophobic properties of the two surfaces corresponding to the first area I and the second area II respectively are different would do. For example, one of the two areas is coated with a hydrophobic material or a hydrophilic material; or, the roughness factor of the first area I is different from that in the second area II.

Moreover, in the present embodiment of the invention, the primary flow path 722, the secondary flow path 732, the air exhaust channel 734, the lateral air exhaust channel 724, and the air intake channel 736 are formed on the substrate 700 by ordinary micro-electromechnical manufacturing method. The hydrophobic material exists in the air exhaust channel 734, the lateral air exhaust channel 724, the air intake channel 736 and a part of the flow path 732, such that the fluid, when driven, still remains within the secondary flow path 732 and the primary flow path 722 and merely dissipates the bubble from the substrate 700, largely resolving the difficulty of dissipating the bubble.

The bubble micro-pump of the present embodiment of the invention forms the bubble indirectly generated on a surface having hydrophilic/hydrophobic property, such that a net fluid flow is generated due to the difference in the backfilling velocity of the fluid when the bubble is dissipated. The bubble micro-pump has low power consumption and uses small driving voltage. Besides, the bubble micro-pump can be driven at normal temperature and prevents the fluid from the variation of pH value. The bubble micro-pump of the present embodiment of the invention is an ideal device for driving the fluid.

According to the bubble micro-pump and two-way fluid-driving device, a particle-sorting device, a fluid-mixing device, a ring-shaped fluid-mixing device and a compound-type fluid-mixing device using the same disclosed in the above embodiments of the invention, the electrolyzing of the fluid to generate a bubble is incorporated with the surface having different roughness, such that when the bubble vanishes, the difference in the backfilling velocity of the fluid generates a pushing force in the fluid. During the repeated cycle of the generation and vanishing of the bubble, a net fluid flow having pump-like effect is generated. The bubble micro-pump has simple structure, and the component having surface roughness gradient can be manufactured by an ordinary micro-electromechnical manufacturing process, hence having low manufacturing cost. The bubble micro-pump of the invention can be used in micro-fluidic systems such as biomedicine, micro-fuel cell, and so on.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bubble micro-pump, comprising:
a first component having a flow path, wherein the flow path has at least a first area and a second area;
a second component disposed above the first component, wherein the second component has a first roughness surface and a second roughness surface, the first roughness surface opposite the first area has a first roughness factor, the second roughness surface opposite the second area has a second roughness factor, and the first roughness factor is substantially greater than the second roughness factor; and
a bubble-generating unit disposed on the first component and used for generating bubbles in the first area and the second area when a fluid fills the vacancy between the first component and the second component;
wherein due to the difference between the first roughness factor and the second roughness factor, when the bubbles generated by the bubble-generating unit start to vanish, the backfilling velocity of the fluid in the first area is greater than the backfilling velocity of the fluid in the second area, such that the fluid is driven to flow.

2. The bubble micro-pump according to claim 1, wherein at least one of the first roughness factor and the second roughness factor increases or decreases along with the flowing direction of the fluid.

3. The bubble micro-pump according to claim 1, wherein at least one of the roughness surfaces of the second component opposite the first area and the second area is formed by a plurality of column elements.

4. The bubble micro-pump according to claim 3, wherein the cross-sectional areas of the column elements dispsoed in different areas of the flow path are substantially different.

5. The bubble micro-pump according to claim 3, wherein each of the column elements is formed by an adjustable membrane, and the curvature of the membrane changes when the deformation of the membrane is adjusted.

6. The bubble micro-pump according to claim 3, wherein there is a recess positioned on the surface of the second component, and the column elements are disposed in the recess.

7. The bubble micro-pump according to claim 6, wherein the first component and the second component at least form an exhaust hole by the recess for dissipating the air generated by the bubble-generating unit.

8. The bubble micro-pump according to claim 1, wherein the second component further comprises a fluid inlet and a fluid outlet corresponding to two sides of the first area and the second area, respectively.

9. The bubble micro-pump according to claim 1, wherein the bubble-generating unit comprises at least an electrode set disposed on the first component, the electrode set comprises:
a first electrode corresponding to the first area; and
a second electrode corresponding to the second area, wherein the polarity of the second electrode is opposite to that of the first electrode.

10. The bubble micro-pump according to claim 1, wherein the material of the flow path of the first component comprises a hydrophilic material.

11. The bubble micro-pump according to claim 1, wherein the material of the second component comprises a hydrophobic material.

12. The bubble micro-pump according to claim 1, wherein the bubble-generating unit comprises:
a substrate having a secondary flow path, at least an air exhaust channel, an air intake channel and a bubble outlet, wherein the air exhaust channel is connected with the front part of the secondary flow path, the air intake channel is connected with the rear part of the secondary flow path, the bubble outlet is located at a terminal of the secondary flow path, the air is taken in via the air intake channel and filled in part of the rear part of the secondary flow path; and
a bubble-generating element disposed at the front part of the secondary flow path;
wherein when the bubble-generating element generates a first bubble in the fluid at the front part of the secondary flow path, the fluid at the rear part of the secondary flow path is pushed to flow towards the terminal of the secondary flow path, such that the air at the rear part of the secondary flow path is pushed by the fluid to flow towards the bubble outlet and forms a second bubble in the first area and the second area.

13. The bubble micro-pump according to claim 12, wherein when the first bubble vanishes from the air exhaust channel and the fluid at front part of the secondary flow path backfills, the fluid at the rear part of the secondary flow path backflows to the front part of the secondary flow path, such that an external air enters the rear part of the secondary flow path via the air intake channel.

14. The bubble micro-pump according to claim 12, wherein the bubble-generating element comprises at least an electrode set having a first electrode and a second electrode, and the polarity of the first electrode is opposite to that of the second electrode.

15. The bubble micro-pump according to claim 12, wherein the substrate has a hydrophobic material disposed on the air exhaust channel.

16. The bubble micro-pump according to claim 12, wherein the substrate has a hydrophobic material disposed on the air intake channel.

17. The bubble micro-pump according to claim 12, wherein the substrate has a hydrophobic material disposed on the rear part of the secondary flow path.

18. The bubble micro-pump according to claim 12, wherein the width at the front part of the secondary flow path is substantially different from that at the rear part of the secondary flow path.

19. The bubble-generating device according to claim 12, wherein the substrate further comprises a fluid inlet disposed at the front end of the secondary flow path.

20. A two-way fluid-driving device, comprising:
a first primary flow path and a second primary flow path alternately disposed to form a common flow path area;
a first driving portion having at least a bubble micro-pump as defined in claim 1, wherein the bubble micro-pump is disposed on the first primary flow path and adjacent to the common flow path area;
a second driving portion having at least a bubble micro-pump as defined in claim 1, wherein the bubble micro-pump is disposed on the second primary flow path and adjacent to the common flow path area; and
a controlling unit electrically connected with the bubble-generating units of the first driving portion and that of the second driving portion;
wherein the first driving portion pushes the fluid in the first primary flow path to flow when the controlling unit drives the first driving portion, and the second driving portion pushes the fluid in the second primary flow path to flow when the controlling unit drives the second driving portion.

21. The two-way fluid-driving device according to claim 20, wherein
the first driving portion comprises two bubble micro-pumps as defined in claim 1 and disposed on two opposite sides of the common flow path area;
the second driving portion comprises two bubble micro-pumps as defined in claim 1 and disposed on the other two opposite sides of the common flow path area.

22. The two-way fluid-driving device according to claim 20, wherein the first primary flow path is substantially perpendicular to the second primary flow path.

23. A particle-sorting device, comprising:
a primary flow path;
a driving portion disposed at the front part of the primary flow path;
a diversion portion having a first branch flow path for connecting with the rear part of the primary flow path, wherein there is a bubble micro-pump as defined in claim 1 disposed on the first branch flow path;
a detecting unit disposed on the primary flow path and located between the driving portion and the diversion portion; and
a controlling unit electrically connected with the driving portion, the detecting unit, and the bubble-generating unit of the diversion portion;
wherein after the driving portion pushes a particle-carrying fluid of the primary flow path to pass the detecting unit to complete particle identification, the detecting unit transmits a signal to the controlling unit for driving the bubble micro-pump of the diversion portion, such that the particles are prevented from flowing to the first branch flow path along with the fluid.

24. The particle-sorting device according to claim 23, wherein the diversion portion further comprises a second branch flow path, and there is a bubble micro-pump as defined in claim 1 disposed on the second branch flow path.

25. The particle-sorting device according to claim 23, wherein the driving portion comprises at least a bubble micro-pump as defined in claim 1, which is disposed on one side of the primary flow path, and electrically connect with the controlling unit.

26. The particle-sorting device according to claim 23, wherein the detecting unit comprises a photo sensor or an electro sensor.

27. A fluid-mixing device, comprising:
a mixing chamber having an inlet flow path and an outlet flow path;
a first driving portion having at least a bubble micro-pump as defined in claim 1 and disposed on the inlet flow path;
a second driving portion having at least a bubble micro-pump as defined in claim 1 and disposed on the outlet flow path; and
a controlling unit electrically connected with the bubble-generating units of the first driving portion and the second driving portion;
wherein after the controlling unit drives the first driving portion to introduce at least two fluids into the mixing chamber via the inlet flow path, the controlling unit alternately drives the second driving portion and the first driving portion repeatedly for guiding the two fluids to enter the mixing chamber via the inlet flow path and leave the mixing chamber via the outlet flow path respectively, such that the two fluids are mixed.

28. The fluid-mixing device according to claim 27, wherein the material of the mixing chamber comprises a transparent material.

29. A ring-shaped fluid-mixing device, comprising:
a ring-shaped primary flow path;
two first branch flow paths connected with the ring-shaped primary flow path;
two second branch flow paths connected with the ring-shaped primary flow path, wherein the first branch flow paths and the second branch flow paths are alternately disposed;
a first driving portion having two bubble micro-pumps as defined in claim 1, disposed on the ring-shaped primary flow path, and adjacent to the two first branch flow paths;
a second driving portion having two bubble micro-pumps as defined in claim 1, disposed on the ring-shaped primary flow path, and adjacent to the two second branch flow paths; and
a controlling unit electrically connected with the bubble-generating units of the first driving portion and the second driving portion;
wherein after different fluids are introduced into the ring-shaped primary flow path via the two first branch flow paths and the two second branch flow paths, the controlling unit alternately drives the first driving portion and the second driving portion, such that the different fluids are mixed in the ring-shaped primary flow path.

30. The ring-shaped fluid-mixing device according to claim 29, wherein the bubble micro-pumps of the first driving portion and the second driving portion are substantially separated by 90 degrees.

31. A compound-type fluid-mixing device, comprising:
a first flow path component having a ring-shaped primary flow path, at least an inlet flow path, at least an outlet flow path, a first driving portion and a second driving portion, wherein the inlet flow path and the outlet flow path are both connected with the ring-shaped primary flow path, the first driving portion is disposed at the junction of the ring-shaped primary flow path and the inlet flow path, the second driving portion is disposed at the junction of the ring-shaped primary flow path and the outlet flow path, each of the first driving portion and the second driving portion has at least a bubble micro-pump as defined in claim 1;
a second flow path component disposed above the first flow path component, wherein the second flow path component has a direct flow path and a third driving portion, the direct flow path is connected with the ring-shaped primary flow path, and the third driving portion has at least two bubble micro-pumps as defined in claim 1 and respectively disposed on two opposite sides of the junction of the direct flow path and the ring-shaped primary flow path; and
a controlling unit electrically connected with the bubble-generating units of the first driving portion, the second driving portion and the third driving portion;
wherein after the controlling unit drives the first driving portion to introduce a fluid into the ring-shaped primary flow path via the inlet flow path and drives the third driving portion to introduce the other fluid into the ring-shaped primary flow path via two sides of the direct flow path, the controlling unit alternately drives the first driving portion and the second driving portion, such that the fluids are mixed in the ring-shaped primary flow path and the mixed fluid is moved by the second driving portion to leave the ring-shaped primary flow path via the outlet flow path.

32. The compound-type fluid-mixing device according to claim 31, wherein the first flow path component comprises two inlet flow paths and two outlet flow paths.

33. The compound-type fluid-mixing device according to claim 32, wherein the inlet flow paths and the outlet flow paths are substantially separated by 90 degrees.

34. The compound-type fluid-mixing device according to claim 32, wherein each of the first driving portion and the second driving portion comprises two bubble micro-pumps as defined in claim 1 and disposed at the junction of the ring-shaped primary flow path and the inlet flow paths and the outlet flow paths.
